(19) United States
(12) Patent Application Publication
(10) Pub. No.: US 2026/0177940 A1
(43) Pub. Date: Jun. 25, 2026

(54) MAGNETIC CARRIER AND TWO-COMPONENT DEVELOPER CONTAINING MAGNETIC CARRIER

(71) Applicant: KYOCERA Document Solutions Inc., Osaka (JP)

(72) Inventor: Yusuke KURANO, Osaka (JP)

(73) Assignee: KYOCERA Document Solutions Inc., Osaka (JP)

(21) Appl. No.: 19/416,694

(22) Filed: Dec. 11, 2025

(30) Foreign Application Priority Data
Dec. 25, 2024 (JP) 2024-228425

(51) Int. Cl. G03G 9/113

(52) U.S. Cl. CPC G03G 9/1139; G03G 9/1136

(57) ABSTRACT

Magnetic carrier include a carrier core and a resin coat layer that coats the surface of the carrier core, and can electrostatically charge toner positively by friction. The resin coat layer contains polyimide silicone resin and silica particles.

### INCORPORATION BY REFERENCE

This application is based on and claims the benefit of priority from Japanese Patent Application No. 2024-228425 filed on Dec. 25, 2024, the contents of which are hereby incorporated by reference.

### BACKGROUND

The present disclosure relates to magnetic carrier that electrostatically charges toner by friction, and also to two-component developer containing magnetic carrier.

In general, in electrophotography, the surface of an electrostatic latent image carrying member is electrostatically charged by corona discharge or the like and is then exposed to laser light or the like to form an electrostatic latent image. The formed electrostatic latent image is developed with toner to form a toner image. The formed toner image is then transferred to a recording medium to obtain a high-quality image. Known methods of developing an electrostatic latent image include a two-component development method, which uses, as developer, two-component developer containing toner and magnetic carrier, and a one-component development method, which uses one-component developer containing no magnetic carrier. Of these, the two-component development method is suitable in cases where higher image quality and higher printing speed are desired.

Two-component developer used in the two-component development method contains magnetic carrier and toner. In development, only the toner is consumed and the carrier is used repeatedly while being stirred in a developing device. To cope with recent demand for higher reliability, resin-coated magnetic particles produced by coating the surface of magnetic particles with resin are used as carrier particles.

### SUMMARY

According to one aspect of the present disclosure, magnetic carrier includes a carrier core and a resin coat layer that coats the surface of the carrier core, and can electrostatically charge toner positively by friction. The resin coat layer contains polyimide silicone resin and silica particles.

### DETAILED DESCRIPTION

An embodiment of the present disclosure will be described in detail below. Unless otherwise defined, a result of evaluation (i.e., a value related to a shape, property, or the like) with respect to a powdery substance (specifically, toner core particle, toner base particle, external additive, toner, or the like) is given as a number average of values obtained respectively for an appropriate number of average particles selected from the powdery substance. Unless otherwise defined, a number average particle size of a powdery substance is a number average value of the circle-equivalent diameter (the diameter of a circle with the same area as the projection area of a particle) of primary particles measured under a microscope. Unless otherwise defined, a measured value of the volume median diameter (D50) of a powdery substance is a value measured using a laser diffraction/scattering particle size distribution analyzer (“LA-750,” manufactured by Horiba Ltd.). Unless otherwise defined, a measured value of an acid number or a hydroxy group number is a value measured in conformity with JIS (Japanese Industrial Standards) K0070-1992. Unless otherwise defined, a measured value of a number average molecular weight (Mn) or a mass average molecular weight (Mw) is a value measured by gel permeation chromatography.

In the following description, “-based” is occasionally appended to the name of a compound to collectively refer to that substance and their derivatives. Wherever the name of a compound has “-based” appended to it in the name of a polymer, the repeating unit in the polymer is derived from any of that compound and their derivatives. The term “(meth)acrylic” is occasionally used to refer to “acrylic” and “methacrylic” collectively. The term “(meth)acryloyl” is occasionally used to refer to “acryloyl” (CH₂═CH—CO—) and “methacryloyl” (CH₂—C(CH₃)—CO—) collectively.

Magnetic carrier according to the present disclosure is a powdery substance composed of a plurality of carrier particles (each configured as described later). The carrier particle according to the present disclosure includes a carrier core and a resin layer that coats the carrier core. To produce the carrier particle, the carrier core can be formed of a magnetic material (such as ferrite) or the carrier core can be formed of resin having magnetic particles dispersed in it. Or magnetic particles can be dispersed in the resin layer that coats the carrier core.

The magnetic carrier according to the present disclosure electrostatically charges positively chargeable toner positively by friction. It together with the positively chargeable toner constitutes two-component developer that can be suitably used to develop an electrostatic latent image. To form high-quality images, the amount of toner in the two-component developer is preferably 5 mass parts or more but 15 mass parts or less for 100 mass parts of the carrier. Note that positively chargeable toner is electrostatically charged positively by friction with carrier.

The magnetic carrier according to the present disclosure can be used, for example, in an electrophotographic apparatus (image forming apparatus). One example of an image forming method on an electrophotographic apparatus will be described below.

First, based on image data, an electrostatic latent image is formed on a photosensitive member (e.g., in a superficial part of a photosensitive drum). Next, the formed electrostatic latent image is developed with two-component developer containing toner and carrier. In the development process, toner (e.g., toner electrostatically charged to be positively charged by friction with carrier) on a development sleeve (e.g., a superficial part of a development roller in a developing device) disposed near the photosensitive member is attached to the electrostatic latent image to form a toner image on the photosensitive member. In the subsequent transfer process, the toner image on the photosensitive member is transferred directly to a recording medium (e.g., paper); or it is first primarily transferred to an intermediate transfer member (e.g., transfer belt) and then the toner image on the intermediate transfer member is secondarily transferred to a recording medium. After that, the toner is heated so that the toner is fixed to the recording medium. In this way, an image is formed on the recording medium. For example, toner images of four colors, namely black, yellow, magenta, and cyan, can be overlaid on each other to form a full-color image.

### [1. Basic Configuration of Magnetic Carrier]

The magnetic carrier according to the present disclosure has a basic configuration as described below. The magnetic carrier is composed of a plurality of carrier particles each having a magnetic carrier core and a resin layer. The resin layer coats the surface of the magnetic carrier core. The resin layer can coat the entire surface of the magnetic carrier core, or can partly coat the surface of the magnetic carrier core. The resin layer contains polyimide silicone resin and silica particles.

Polyimide silicone resin excels in toner filming properties and durability and has low moisture permeability. Silica particles excel in the ability to electrostatically charge positively chargeable toner and the ability to polish the surface of a photosensitive member. Thus, by forming images using two-component developer containing the magnetic carrier with the basic configuration described above, it is possible to maintain excellent charging and charge retaining abilities even in a high-temperature high-humidity environment and to form high-quality images for a long period.

### [2. Basic Configuration of Toner]

The magnetic carrier according to the embodiment is mixed with toner for use as two-component developer. As the toner used with the magnetic carrier, any known positively chargeable toner for two-component developer can be used.

The toner is composed of a plurality of toner particles including toner core particles. The toner core particle at least contains a binder resin, a release agent, and a colorant. The surface of the toner core particle can be coated with a shell layer. Preferably, the shell layer covers 50% or more but 99% or less of the area of the surface region of the toner core particle. The entire surface of the toner core particle can be coated with the shell layer. In a case where the toner core particle is coated with a shell layer, the particle including the toner core particle and the shell layer is the toner base particle. In a case where the toner core particle is not coated with a shell layer, the toner core particle is the toner base particle.

The thickness of the shell layer can be measured by inspecting a section of the toner on a transmission electron microscope (TEM) and analyzing a TEM scan image with commercially available image analysis software. As commercially available image analysis software, WinROOF (produced by Mitani Corporation) or the like can be used. The coating condition on the surface of the toner with the shell layer can be checked on a scanning electron microscope (SEM). The formation condition and the inside of the shell layer can be checked by inspecting a section of the toner on a transmission electron microscope (TEM).

The surface of the toner base particle can have an external additive attached to it. As the external additive, inorganic particles or resin fine particles can be used. Attaching resin fine particles as an external additive to the toner base particle tends to enhance the cleaning properties (e.g., resistance to adhesion to a photosensitive drum) and the developing properties (e.g., transfer efficiency) of the toner. This is considered to be because the resin fine particles function as a spacer and make the toner less likely to adhere to a photosensitive drum, an intermediate transfer belt, or the like.

### [3. Materials and Production Method for the Magnetic Carrier]

Next, the essential or optional components of the magnetic carrier according to the present disclosure will be described. The magnetic carrier according to the present disclosure at least includes a carrier core and a resin coat layer. As necessary, a conductive agent can be contained in the resin coat layer. A description will now be given of, one by one, the carrier core that forms a magnetic carrier particle, the resin material that forms the resin coat layer, the conductive agent, and the production method for the magnetic carrier according to the present disclosure.

### (Carrier Core)

There is no particular limitation on the carrier core and, for it, any substance known for use as carrier for an electrophotographic two-component system can be used, examples including: ferrite, magnetite, or a metal such as iron, nickel, or cobalt; an alloy or mixture of any of the aforementioned metals and the like with a metal such as copper, zinc, antimony, aluminum, lead, tin, bismuth, beryllium, manganese, magnesium, selenium, tungsten, zirconium, or vanadium; a mixture of any of the aforementioned substances such as ferrite with a metal oxide such as iron oxide, titanium oxide, or magnesium oxide, or a nitride such as a chromium nitride or vanadium nitride, or a carbide such as silicon carbide or tungsten carbide; or ferromagnetic ferrite. Of these, ferrite and magnetite are particularly preferable.

The volume average particle size of the carrier core is preferably 20 to 70 μm. This provides satisfactory developing properties. The volume average particle size can be measured using a laser diffraction/scattering particle size analyzer. Usable as a laser diffraction/scattering particle size analyzer is, for example, LA-750 (manufactured by Horiba, Ltd.).

### (Resin Material)

Used as the resin that forms the resin coat layer is a mixture of polyimide silicone resin, which excels in toner filming properties and durability and which has low moisture permeability, with silica particles, which excel in the ability to electrostatically charge positively chargeable toner and the ability to polish the surface of a photosensitive drum.

Polyimide silicone resin is a copolymer having a polyimide structure and a polysiloxane structure (e.g., alkyl polysiloxane structure). Examples of polyimide silicone resin include “KJR-651”, “KJR-655”, “KJR-657,” and “KJR-663” (all manufactured by Shin-Etsu Chemical Co., Ltd.). The polyimide silicone resin can be resin obtained by setting thermosetting polyimide silicone resin.

The silica particles have an average particle size (volume median diameter) of preferably 15 nm to 150 nm, and more preferably 30 nm or more but 100 nm or less.

The mix ratio of polyimide silicone resin to silica particles is preferably 1:9 to 9:1, and more preferably 2:8 to 8:2.

### (Conductive Agent)

Preferably, the resin coat layer further contains a conductive agent. The resin coat layer further containing a conductive agent makes it possible to adjust the electrical resistance and the toner charging ability of the carrier particle.

Usable as the conductive agent are, for example, carbon black (in particular, conductive carbon black), particles of metal oxides (such as titanium oxide particles and tin oxide particles), and organic conductive agents. As the conductive agent, carbon black or titanium oxide particles are preferred.

In a case where the resin coat layer contains carbon black, the amount of carbon black contained is, for 100 mass parts of the coating resin, preferably 1.0 mass part or more but 10.0 mass parts or less, and more preferably 2.0 mass parts or more but 6.0 mass parts or less.

### (Additives)

The resin coat layer can contain, as an additive, at least one of a charge control agent, an adhesion enhancing agent, and a cross-linking agent. As an additive, a silane coupling agent (or a component derived from a silane coupling agent) is preferable, and an aminosilane coupling agent (or a component derived from an aminosilane coupling agent) is more preferable. An aminosilane coupling agent (or a component derived from an aminosilane coupling agent) has the functions of a charge control agent, an adhesion enhancing agent, and a cross-linking agent.

In a case where the resin coat layer contains an additive, the amount of additive contained is, for 100 mass parts of the coating resin, preferably 4.0 mass parts or more but 20.0 mass parts or less, and more preferably 8.0 mass parts or more but 15.0 mass parts or less.

### (Production Method for the Magnetic Carrier)

One example of the production method for the carrier according to the present disclosure will be described. The production method for the carrier includes an application step in which a resin coat layer forming solution is applied to the carrier core and a heating step in which the carrier core having undergone the application step is heated. The resin coat layer forming solution contains polyimide silicone resin, silica particles, a solvent, and any other components added as necessary (e.g., a conductive agent and an additive). The polyimide silicone resin can be a thermosetting polyimide silicone resin.

Examples of the solvent for the resin coat layer forming solution include, for example, lactam compounds (e.g., 2-pyrrolidone and N-methyl-2-pyrrolidone), ketone compounds (e.g., methyl ethyl ketone and methyl isobutyl ketone), cyclic ether compounds (e.g., tetrahydrofuran and tetrahydropyran), alcohol compounds (e.g., normal butanol and isobutanol), ester solvents (e.g., ethyl acetate and isobutyl acetate), and aromatic hydrocarbon compounds (e.g., toluene and xylene). Preferred as the solvent for the resin coat layer forming solution is N-methyl-2-pyrrolidone.

The solid content concentration in the resin coat layer forming solution is preferably 3 mass % or more but 20 mass % or less.

### (Application Step)

Examples of methods of applying the resin coat layer forming solution to the carrier core include, for example, immersing the carrier core in the resin coat layer forming solution and spraying the carrier core in a fluidized bed with the resin coat layer forming solution. In the method where the carrier core is immersed in the resin coat layer forming solution, to elevated parts of the surface of the carrier core, a small amount of resin coat layer forming solution is applied and to depressed parts of the surface of the carrier core, a large amount of resin coat layer forming solution is applied; thus the resin coat layer forming solution tends to be applied in uneven amounts. In contrast, in the method where the resin coat layer forming solution is sprayed to the carrier core in the fluidized bed, the resin coat layer forming solution tends to be applied evenly to both elevated and depressed parts of the surface of the carrier core. Thus, preferred as the method of applying the resin coat layer forming solution to the carrier core is spraying the resin coat layer forming solution to the carrier core in the fluidized bed.

### (Heating Step)

In this step, the carrier core after the application step is heated to remove the solvent contained in the resin coat layer forming solution. If the resin coat layer forming solution contains unset polyimide silicone resin, the unset polyimide silicone resin is set by heat. As a result, a resin coat layer is formed from the resin coat layer forming solution. The heating can be performed under the conditions of, for example, a heating temperature of 200° C. or more but 300° C. or less and a heating time of 30 minutes or more but 90 minutes or less.

### [4. Materials and Production Method for Toner]

Next, the essential or optional components of the toner to be mixed with the magnetic carrier according to the present disclosure will be described. The toner core particle contains, in the binder resin, at least a release agent and a colorant. It can also contain, as necessary, a charge control agent, a magnetic powder, and the like. If so desired, the toner can have its surface treated with an external additive.

A description will now be given of, one by one, the binder resin, the release agent, the charge control agent, the colorant, and the magnetic powder that form the toner core particle, the shell material for a case where a shell layer is formed, the external additive, and the production method for the toner.

### (Binder Resin)

The toner core particle that forms the toner contains a binder resin. There is no particular restriction on the binder resin that can be contained in the toner core particle so long as it is a resin known to be used as a binder resin in toner. Specific examples of the binder resin include thermoplastic resins such as styrene-based resins, acrylic-based resins, styrene-acrylic-based resins, polyethylene-based resins, polypropylene-based resins, vinyl chloride-based resins, polyester resins, polyamide resins, polyurethane resins, polyvinyl alcohol-based resins, vinyl ether-based resins, N-vinyl-based resins, and styrene-butadiene resins. Among these resins, a polyester resin is preferred from the viewpoints of the dispersion properties of the colorant in the binder resin, the charging properties of the toner, and the fixing properties on sheets. Hereinafter, a description will be given of the polyester resin.

Usable as the polyester resin are those obtained by condensation polymerization or condensation copolymerization of a dihydric or a trihydric or higher alcohol component and a divalent or a trivalent or higher carboxylic acid component. Examples of components used to synthesize a polyester resin include alcohol components and carboxylic acid components as mentioned below.

Specific examples of dihydric or trihydric or higher alcohol components include diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentaerythritol, dipentaerythritol, tripentaerythritol, 1,2,4-butantriol, 1,2,5-pentantriol, glycerol, diglycerol, 2-methylpropan triol, 2-methyl-1,2,4-butantriol, trimethylolethane, trimethylolpropane, and 1,3,5-trihydroxymethylbenzene.

Specific examples of divalent or trivalent or higher carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane thicarboxylic acid, 1,3-dicarboxyl-2-methyl-2-methylenecarboxypropane, 1,2,4-cyclohexane tricarboxylic acid, tetra (methylene carboxyl) methane, 1,2,7,8-octane tetracarboxylic acid, pyromellitic acid, and empole trimer acid. These divalent or trivalent or higher carboxylic acid components can be used as ester-forming derivatives such as acid halides, acid anhydrides, and lower alkyl esters. Here, the term “lower alkyl” denotes an alkyl group with one to six carbon atoms.

When the binder resin is a polyester-based resin, the softening point of the polyester-based resin is preferably 70° C. or more but 130° C. or less, and more preferably 80° C. or more but 120° C. or less. For improved mechanical strength of the toner core and improved fixing properties of the toner, the number average molecular weight (Mn) of the polyester resin is preferably 1000 or more but 2000 or less. The molecular weight distribution of the polyester resin (the ratio Mw/Mn of the mass average molecular weight (Mw) of the polyester resin to its number average molecular weight (Mn)) is preferably 9 or more but 21 or less.

As the binder resin, it is preferable to use a thermoplastic resin for its satisfactory fixing properties on sheets. Here, a thermoplastic resin can be used not only singly but also with a cross-linking agent or a thermosetting resin added to it. Adding a cross-linking agent or a thermosetting resin so that the binder resin partly has a cross-linked structure helps improve the heat-resistant preservation properties, durability, and the like of the toner without degrading the fixing properties of the toner. When a thermosetting resin is used, the cross-linked fraction (gel fraction) of the binder resin extracted using a Soxhlet extractor is preferably, relative to the mass of the binder resin, 10 mass % or less, and more preferably 0.1 mass % or more but 10 mass % or less.

As a thermosetting resin useable with a thermoplastic resin, an epoxy resin or a cyanate-based resin is preferred. Specific examples of suitable thermosetting resins include bisphenol A-type epoxy resins, hydrogenated bisphenol A-type epoxy resins, novolak-type epoxy resins, polyalkylene ether-type epoxy resins, cyclic aliphatic compound-type epoxy resins, and cyanate resins. Two or more of these thermosetting resins can be used in combination.

The glass transition point (Tg) of the binder resin is preferably 40° C. or more but 70° C. or less. Too high a glass transition point tends to lead to poor low-temperature fixing properties of the toner. Too low a glass transition point tends to lead to poor heat-resistant preservation properties of the toner.

The glass transition point of the binder resin can be determined from the changing point of the specific heat of the binder resin using a differential scanning calorimeter (DSC). More specifically, the glass transition point of the binder resin can be determined by drawing the endothermic curve of the binder resin using as a measuring instrument a differential scanning calorimeter (DSC-6200, manufactured by Seiko Instruments Inc). 10 mg of a measurement sample is put in an aluminum pan, while a vacant aluminum pan is used as a reference. From the endothermic curve of the binder resin drawn through measurement in a normal-temperature normal-humidity environment in the range of measurement temperature from 25° C. to 200° C. at a heating rate of 10° C. per minute, the glass transition point of the binder resin can be determined.

The mass average molecular weight (Mw) of the binder resin is not particularly limited within the scope consistent with the object of the present disclosure. Typically, the mass average molecular weight (Mw) of the binder resin is preferably 20,000 or more but 300,000 or less, and more preferably 30,000 or more but 200,000 or less. The mass average molecular weight of the binder resin can be determined by gel permeation chromatography (GPC) using a standard curve previously prepared using a standard polyethylene resin.

### (Colorant)

The toner core particle contains a colorant. As the colorant that can be contained in the toner core particle, any known pigment or dye that suits the color of the toner can be used. Specific examples of suitable colorants that can be added to the toner include black pigments such as carbon black, acetylene black, lamp black, and aniline black; yellow pigments such as chrome yellow, zinc yellow, cadmium yellow, yellow iron oxide, mineral fast yellow, nickel titanium yellow, Naples yellow, naphthol yellow S, Hansa yellow G, Hansa yellow 10G, benzidine yellow G, benzidine yellow GR, quinoline yellow lake, permanent yellow NCG, tartrazine lake, monoazo yellow, and diazo yellow; orange pigments such as reddish chrome yellow, molybdenum orange, permanent orange GTR, pyrazolone orange, Vulcan Orange, and indanthrene brilliant orange GK; red pigments such as red iron oxide, cadmium red, red lead, mercury cadmium sulfide, permanent red 4R, lithol red, pyrazolone red, Watchung red calcium salt, lake red D, brilliant carmine 6B, eosine lake, rhodamine lake B, alizarin lake, brilliant carmine 3B, and monoazo red; violet pigments such as manganese violet, fast violet B, and methyl violet lake; blue pigments such as Prussian blue, cobalt blue, alkali blue lake, partially chlorinated Victoria blue, fast sky blue, indanthrene blue BC, and phthalocyanine blue; green pigments such as chrome green, chromium oxide, pigment green B, malachite green lake, and final yellow green G; white pigments such as zinc white, titanium oxide, antimony white, and zinc sulfide; and extender pigments such as barite powder, barium carbonate, clay, silica, white carbon, talc, and alumina white. Two or more of these pigments can be used in combination for the purpose, among others, of adjusting the toner to the desired hue.

The amount of colorant used is not particularly limited within the scope consistent with the object of the present disclosure. Specifically, the amount of colorant used is, for the total mass of the toner core particle, preferably 1 mass % or more but 10 mass % or less, and more preferably 2 mass % or more but 7 mass % or less.

A colorant can be used as a master batch having the colorant previously dispersed in a resin material such as a thermoplastic resin. When a colorant is used as a master batch, the resin contained in the master batch is preferably a resin of the same type as the binder resin.

### (Release Agent)

For the purpose of improving its fixing properties and anti-offsetting properties, the toner core particle can contain a release agent. The type of release agent that can be contained in the toner core particle is not limited within the scope consistent with the object of the present disclosure. As the release agent, wax is preferred. Examples of wax include carnauba wax, synthetic ester wax, polyethylene wax, polypropylene wax, fluorocarbon-based wax, Fischer-Tropsch wax, paraffin wax, montan wax, and rice wax. Two or more of these release agents can be used in combination. Adding these release agents to the toner core particle helps more effectively suppress offsetting and image smearing (stain around an image caused by its being rubbed).

When a polyester resin is used as the binder resin, from the viewpoint of compatibility, as the release agent, one or more release agents selected from the group consisting of carnauba wax, synthetic ester wax, and polyethylene wax are suitably used. When a polystyrene-based resin is used as the binder resin, likewise from the viewpoint of compatibility, as the release agent, Fischer-Tropsch wax and/or paraffin wax is suitably used.

Fischer-Tropsch wax is a straight-chain hydrocarbon compound with few iso-structure molecules or side chains that is produced by exploiting the Fischer-Tropsch reaction, which is a catalytic hydrogenation reaction of oxygen monoxide.

Preferred among different types of Fischer-Tropsch wax are those that have a mass average molecular weight of 1,000 or more and of which the bottom temperature of the exothermal peak observed by DSC measurement falls within the range of 100° C. or more but 120° C. or less. Examples of such types of Fischer-Tropsch wax include the following products available from Sasol: Sasol Wax C1 (exothermic peak bottom temperature: 106.5° C.), Sasol Wax C105 (exothermic peak bottom temperature: 102.1° C.), and Sasol Wax Spray (exothermic peak bottom temperature: 102.1° C.).

The amount of release agent used is not particularly limited within the scope consistent with the object of the present disclosure. Specifically, the amount of release agent used is preferably, relative to the total mass of the toner core particle, 1 mass % or more but 10 mass % or less. Using too small an amount of release agent can result in insufficient suppression of offsetting and image smearing in the formed images; using too large an amount of release agent can result in fusing-together of toner particles and hence poor heat-resistant preservation properties of the toner

### (Charge Control Agent)

The toner core particle can contain a charge control agent for the purpose of improving the charge level of the toner and its charge response properties as an index of whether it can be charged to a predetermined charge level in a short time and thereby obtaining toner with excellent durability and stability. With the magnetic carrier according to the present disclosure, development is performed by electrostatically charging toner positively; accordingly, here, a positively chargeable charge control agent is used.

The type of charge control agent that can be contained in the toner core particle is not particularly limited within the scope consistent with the object of the present disclosure. Any of charge control agents known to be used in toner can be appropriately selected and used. Specific examples of positively chargeable charge control agents include azine compounds such as pyridazine, pyrimidine, pyrazine, orthoxazine, metaoxazine, paraoxiazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes comprising azine compounds, such as azine fast red FC, azine fast red 12BK, azine violet BO, azine brown 3G, azine light brown GR, azine dark green BH/C, azine deep black EW, and azine deep black 3RL; nigrosine compounds such as nigrosine, nigrosine salts, and nigrosine derivatives; acid dyes comprising nigrosine compounds, such as nigrosine BK, nigrosine NB, and nigrosine Z; metal salts of naphthenic acid or higher fatty acids; alkoxylated amines; alkylamides; and quaternary ammonium salts such as benzylmethylhexyldecylammonium and decyltrimethylammonium chloride. Among these positively chargeable charge control agents, nigrosine compounds are particularly preferred for their faster charge response properties. Two or more of these positively chargeable charge control agents can be used in combination.

Also usable as a positively chargeable charge control agent are resins that have as a functional group a quaternary ammonium salt, a carboxylic acid salt, or a carboxyl group. Specific examples include styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weight of these resins are not particularly limited within the scope consistent with the object of the present disclosure, and they can be in the form of an oligomer or a polymer.

Among resins usable as a positively chargeable charge control agent, from the viewpoint of easy adjustment of the amount of charge within a desired range, styrene-acrylic-based resin having as a functional group a quaternary ammonium salt is more preferred. In styrene-acrylic-based resins having as a functional group a quaternary ammonium salt, specific examples of preferred acrylic-based comonomers for copolymerization with the styrene unit include esters of alkyl (meth)acrylates such as methyl acrylate, ethyl acrylate, n-propyl acrylate, isopropyl acrylate, n-butyl acrylate, isobutyl acrylate, 2-ethylhexyl acrylate, methyl methacrylate, ethyl methacrylate, n-butyl methacrylate, and isobutyl methacrylate.

Used as a quaternary ammonium salt is a unit derived by a quarternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethyl aminoethyl (meth)acrylate, diethyl aminoethyl (meth)acrylate, dipropyl aminoethyl (meth)acrylate, and dibutyl aminoethyl (meth)acrylate. Specific examples of dialkyl (meth)acryl amide include dimethyl methacryl amide. Specific examples of dialkyl aminoalkyl (meth)acryl amide include dimethyl aminopropyl methacryl amide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamide can be used together.

The amount of charge control agent used is not particularly limited within the scope consistent with the object of the present disclosure. Typically, the amount of charge control agent used is preferably 0.1 mass % or more but 10 mass % or less of the total mass of the toner core particle. Using too small an amount of charge control agent makes it difficult to stably charge the toner with a predetermined polarity. This can lead to a lower-than-expected image density in the formed image and make it difficult to maintain satisfactory image density for a long period. Also the charge control agent is then difficult to disperse evenly, and this tends to cause fogging in the formed image and contamination of a latent image carrying member with toner components. Using too large an amount of charge control agent leads to poorer resistance to environment, resulting in image defects in the formed image due to insufficient charging under high temperature and high humidity and contamination of a latent image carrying member with toner components.

### (Shell Material)

If a shell layer is formed on the surface of the toner core particle, the shell layer is formed of, for example, a vinyl-based resin. As the vinyl-based resin used to form the shell layer, a resin containing a charge control resin is used. With the shell layer formed of a resin containing a charge control resin, when images are formed for a long period in various environments such as a high-temperature high-humidity environment and a low-temperature low-humidity environment, it is possible to charge the toner with the desired charge amount and to form images with the desired density.

Preferably, the vinyl-based resin is a styrene-acrylic acid-based resin containing a styrene-based monomer and one or more types of acrylic acid-based monomers. The styrene-acrylic acid-based resin has strong hydrophobicity and tends to be easy to charge positively. It is considered that forming the shell layer of styrene-acrylic acid-based resin gives it a higher affinity with the resin fine particles formed of silicone-modified acrylic resin that are attached as an external additive to the toner base particle, suppressing the coming-off of the resin fine particles from the shell layer.

The amount of vinyl-based resin used is not particularly limited within the scope consistent with the object of the present disclosure. Typically, the amount of vinyl-based resin used is preferably, for 100 mass parts of the toner core particle, 1 mass part or more but 20 mass parts or less, and more preferably 3 mass parts or more but 15 mass parts or less. Using too small an amount of vinyl-based resin may result in the shell layer failing to coat the entire surface of the toner core particle. If the shell layer fails to coat the entire surface of the toner core particle, the toner tends to agglomerate during storage at high temperature, leading to poor heat-resistant preservation properties. On the other hand, using too large an amount of vinyl-based resin tends to increase the thickness of the shell layer. This makes it difficult to produce toner that excels in fixing properties.

The mass average molecular weight (Mw) of the vinyl-based resin used to form the shell layer is not particularly limited within the scope consistent with the object of the present disclosure. Typically, the mass average molecular weight is preferably 20,000 or more but 1,500,000 or less, and more preferably 200,000 or more but 400,000 or less. The mass average molecular weight (Mw) of the vinyl-based resin can be measured by gel permeation chromatography according to any known method.

A method of polymerizing the monomer (monomeric substance) described above is not particularly limited within the scope consistent with the object of the present disclosure, and thus any of methods such as solution polymerization, bulk polymerization, emulsion polymerization, and suspension polymerization can be selected.

In a case where, as in emulsion polymerization or suspension polymerization, a monomer having an unsaturated bond is addition-polymerized using an aqueous solvent, a surfactant can be used. The surfactant is not particularly limited within the scope consistent with the object of the present disclosure and can be appropriately selected from the group consisting of anionic surfactants, cationic surfactants, and nonionic surfactants. Examples of anionic surfactants include sulfate ester salt-type surfactants, sulfonate salt-type surfactants, phosphate ester salt-type surfactants, and soap. Examples of cationic surfactants include amine salt-type surfactants and quaternary ammonium salt-type surfactants. Examples of nonionic surfactants include polyethylene glycol-type surfactants, alkylphenol-ethylene oxide adduct-type surfactants, and polyhydric alcohol-type surfactants that are a derivative of a polyhydric alcohol such as glycerin, sorbitol, or sorbitan. Among these surfactants, at least one of an anionic surfactant and a nonionic surfactant is preferably used. Of these surfactants, one type can be used singly or two or more can be used in combination.

### (External Additive)

In the toner, the toner base particle can have, as desired, its surface treated with an external additive. The type of external additive is not particularly limited within the scope consistent with the object of the present disclosure and thus can be selected appropriately from external additives known to be used in toner. Specific examples of suitable external additives include inorganic fine particles of silica or a metal oxide or the like such as alumina, titanium oxide, magnesium oxide, zinc oxide, strontium titanate, or barium titanate, or resin fine particles of acrylic resin, silicone-modified acrylic resin, or the like. Two or more of these external additives can be used in combination.

The particle size of the external additive is not particularly limited within the scope consistent with the object of the present disclosure. Typically, it is preferably 0.01 μm or more but 1.0 μm or less.

The amount of external additive used is not particularly limited within the scope consistent with the object of the present disclosure. Typically, the amount of external additive used is preferably, for the total mass of the toner base particle produced with the shell layer formed on the surface of the toner core particle, 0.1 mass % or more but 10 mass % or less, and more preferably 0.2 mass % or more but 5 mass % or less. Using too small an amount of external additive can lead to poor hydrophobicity of the toner. As a result, the toner is more susceptible to water molecules in air in a high-temperature high-humidity environment, leading to problems such as low image density of the formed image due to extremely low charge amount of the toner and low fluidity of the toner. Using too large an amount of external additive can result in low image density due to excessive charging of the toner.

Next, the production method for the toner will be described. The production method for the toner is not particularly limited so long as it can form the toner core particle and the shell layer with predetermined structures respectively. As necessary, using as the toner base particle the toner core particle coated with the shell layer, external addition treatment can be applied to the surface of the toner base particle to attach the external additive to it. As a suitable production method for the toner described above for development of electrostatic latent images, a method for producing the toner core particle, a method for forming the shell layer, and a method for external addition treatment will be described one by one below.

### (Method for Producing Toner Core Particle)

The method for producing the toner core particle is not particularly limited so long as it can satisfactorily disperse any optional components such as a colorant, a release agent, a charge control agent, and a magnetic powder in the binder resin. In one specific example of a suitable method for producing the toner core particle, the binder resin and any components such as a colorant, a release agent, a charge control agent, and a magnetic powder are mixed using a mixer or the like; then the binder resin and the components blended in the binder resin are melted and kneaded using a kneader such as a uniaxial or biaxial extruder; and the cooled kneaded product is pulverized and classified. The average particle size of the toner core particle is not particularly limited within the scope consistent with the object of the present disclosure; in general, it is preferably 5 μm or more but 10 μm or less.

### (Method for Forming Shell Layer)

To form the shell layer, fine particles of vinyl-based resin are attached to the surface of the toner core particle to coat it.

The method will be described more specifically. First, in a mixing apparatus, hydrochloric acid is added to ion-exchange water to prepare an aqueous solvent with weak acidity (e.g., with a pH value selected from the range of three or more but five or less). Subsequently, to the aqueous solvent with the so adjusted pH value, a dispersion liquid (suspension) of fine particles of the vinyl-based resin as a shell material and the toner core particles are added.

Subsequently, while the mixture liquid containing the shell material and the toner core particle mentioned above is stirred, the temperature of the mixture liquid is raised up to a predetermined holding temperature (e.g., a temperature selected from the range of 50° C. or more but 90° C. or less) at a predetermined rate (e.g., a rate selected from the range of 0.1° C./min or more but 3° C./min or less). Then, the mixture liquid is, while being stirred, held at the just-mentioned predetermined holding temperature for a predetermined time (e.g., a length of time selected from the range of 30 minutes or more but 4 hours or less). It is considered that, while the temperature of the mixture liquid is held high, a reaction (fixation of the shell layer) proceeds between the toner core particle and the shell material. The shell material binds to the toner core particle to form the shell layer. The formation of the shell layer on the surface of the toner core particle in the mixture liquid yields a dispersion liquid of toner base particles.

As described above, attaching fine particles of vinyl-based resin, which is hydrophobic, to the surface of the toner core particle in the mixture liquid and heating the mixture liquid permits the fine particles of vinyl-based resin to melt and form a film. Instead, the fine particles of vinyl-based resin can be heated in a drying step or subjected to physical impact in an external addition step, to promote their film formation.

After the shell layer is formed as described above, the dispersion liquid of toner base particles is neutralized using, for example, sodium hydroxide. Subsequently, the dispersion liquid of toner base particles is cooled to, for example, normal temperature (about 25° C.). Then, the dispersion liquid of toner base particles is filtered using, for example, a Buchner funnel. This separates the toner base particles from the liquid (solid-liquid separation) and yields toner base particles in the form of a wet cake. Next, the obtained toner base particles in the form of a wet cake are washed. The washed toner base particles are then dried. After that, as necessary, using a mixer (e.g., an FM mixer manufactured by Nippon Coke & Engineering Co., Ltd.), the toner base particles and the external additive can be mixed to attach the external additive to the surface of the toner base particles. If a spray drier is used in the drying step, spraying the dispersion liquid of the external additive (e.g., silica particles) to the toner base particles makes it possible to carry out the drying step and the external addition step at the same time. In this way, toner including a large number of toner particles is produced.

The steps involved and their order in the method for producing toner described above can be freely changed depending on the desired configuration or properties of the toner. After the external addition step, the toner can be sieved. Any unnecessary step can be omitted. For example, if a commercially available product can be used as it is as a material, using the commercially available product helps eliminate a step of preparing that material. Likewise, if a reaction to form the shell layer satisfactorily proceeds without the adjustment of the pH value of the mixture liquid, a pH adjusting step can be omitted. If no external additive is attached to the surface of the toner base particle (an external addition step is omitted), the toner base particle corresponds to the toner particle. To produce toner efficiently, it is preferable to form a large number of toner particles at the same time. The toner particles produced at the same time are considered to share substantially the same configuration.

### (Method for External Addition Treatment)

The method for treatment of the toner base particle with the external additive is not particularly limited; the toner base particle can be treated by any known method. Specifically, the toner base particle is treated with the external additive using a mixer such as a Henschel mixer or a Nauta mixer under treatment conditions adjusted such that the particles of the external additive do not sink in the toner base particle.

The two-component developer that contains the magnetic carrier according to the present disclosure along with toner excels in fixing properties and heat-resistant preservation properties. In cases where images are formed for a long period in various environments including a high-temperature high-humidity environment and a low-temperature low-humidity environment, the toner can be electrostatically charged to a desired charge amount. Thus, the images can be formed with the desired density. Accordingly, the two-component developer according to the present disclosure can be suitably used in a variety of image forming apparatuses. Now, the effects of the present disclosure will be described more specifically by way of examples. The present disclosure is not limited in any way by those examples.

### EXAMPLES

### Production Example 1

### (Production of Toner Core Particle)

As the binder resin, for 100 mass parts of polyester resin (XPE258, manufactured by Mitsui Chemicals, Inc.), 5 mass parts of polypropylene wax (660P, manufactured by Sanyo Chemical Industrial Co. Ltd.), 5 mass parts of carbon black (REGAL330R, manufactured by Cabot Corporation.), and 1 mass part of a charge control agent (BONTRON P-51, manufactured by Orient Chemical Industries Co., Ltd.) were weighed. All these were mixed using a Henschel mixer (FM-10B, manufactured by Nippon Coke & Engineering Co., Ltd.), and then the mixture was melted and kneaded using a biaxial extruder. The obtained kneaded product was cooled, and was then pulverized and classified to obtain toner core particles with a volume average particle size of 7 μm. The volume average particle size was measured using a Coulter Counter Multisizer 3 (manufactured by Beckman Coulter, Inc.).

### Production Example 2

### (Production of Toner)

To the toner core particles obtained in production example 1, relative to their total mass, 1.0 mass % of titanium oxide (EC-100, manufactured by Titan Kogyo, Ltd.) and 0.7 mass % of hydrophobic silica (RA-200H, manufactured by Nippon Aerosil Co., Ltd.) treated with aminosilane were added. The mixture was then mixed for five minutes at a rotation rate of 3500 rpm using a Henschel mixer (FM-10B, manufactured by Nippon Coke & Engineering Co., Ltd.) to obtain toner for development of electrostatic latent images.

### Production Example 3

### (Production of Magnetic Carrier)

40 mass parts of manganese oxide (MnO), 9 mass parts of magnesium oxide (MgO), 50 mass parts of iron (III) oxide (Fe₂O₃), and 1 mass part of strontium oxide (SrO) were blended together and pulverized for two hours using a ball mill. The product was then baked for five hours at 1000° C. to obtain manganese-based ferrite particles. The obtained magnetic particles had a particle size of 40 μm and a saturation magnetization of 65 Am²/kg (under application of 3000×10^{3/4}×A/m). Polyimide silicone resin (KJR-651, manufactured by Shin-Etsu Chemical Co., Ltd.) and silica particles (AEROSIL 90G, manufactured by Nippon Aerosil Co., Ltd.) were dispersed in a mass ratio of 5:5 in N-methyl-2-pyrrolidone to obtain coating resin. 100 mass parts of the magnetic particles (carrier core) were spray-coated with 3 mass parts of the coating resin using a fluidized bed-coating machine. The product was then subjected to heat treatment in the fluidized bed for an hour at 230° C. to set the resin to obtain carrier of Practical Example 1 of the present disclosure.

Carrier of Practical Example 2 was obtained in a manner similar to Practical Example 1 except that polyimide silicone resin (KJR-651, manufactured by Shin-Etsu Chemical Co., Ltd.) and silica particles (AEROSIL 90G, manufactured by manufactured by Nippon Aerosil Co., Ltd.) were dispersed in a mass ratio of 2:8 in N-methyl-2-pyrrolidone to obtain coating resin.

Carrier of Practical Example 3 was obtained in a manner similar to Practical Example 1 except that polyimide silicone resin (KJR-651, manufactured by Shin-Etsu Chemical Co., Ltd.) and silica particles (AEROSIL 90G, manufactured by manufactured by Nippon Aerosil Co., Ltd.) were dispersed in a mass ratio of 8:2 in N-methyl-2-pyrrolidone to obtain coating resin.

Carrier of Practical Example 4 was obtained in a manner similar to Practical Example 1 except that, to 100 mass parts of the coating resin, 4 mass parts of carbon black (#3230B, manufactured by Mitsubishi Chemical Corporation) were added and 100 mass parts of the magnetic particles (carrier core) were spray-coated with 4 mass parts of the coating resin using a fluidized bed-coating machine.

Carrier of Practical Example 5 was obtained in a manner similar to Practical Example 1 except that, to 100 mass parts of the coating resin, 6 mass parts of titanium oxide (EC-100, manufactured by Titan Kogyo, Ltd.) were added and 100 mass parts of the magnetic particles (carrier core) were sprayed-coated with 1 mass part of the coating resin using a fluidized bed-coating machine.

Carrier of Practical Example 6 was obtained in a manner similar to Practical Example 1 except for the use of silica particles hydrophobized by being exposed to a 5% diluted solution of HMDS (hexamethyldisilazane) in toluene in an environment heated to 80° C.

Carrier of Practical Example 7 was obtained in a manner similar to Practical Example 1 except that, to 100 mass parts of the coating resin obtained by dispersing, in N-methyl-2-pyrrolidone, polyimide silicone resin (KJR-651, manufactured by Shin-Etsu Chemical Co., Ltd.) and tetrafluoroethylene-perfluoroalkylvinylether copolymer (PFA) resin fine particles in a mass ratio of 5:5, 4 mass parts of carbon black (#3230B, manufactured by Mitsubishi Chemical Corporation) were added and 100 mass parts of the magnetic carrier (carrier core) were spray-coated with 3 mass parts of the coating resin using a fluidized bed-coating machine.

Carrier of Comparative Example 1 was obtained in a manner similar to Practical Example 1 except that polyimide silicone resin (KJR-651, manufactured by Shin-Etsu Chemical Co., Ltd.) was dispersed in N-methyl-2-pyrrolidone to obtain coating resin.

Carrier of Comparative Example 2 was obtained in a manner similar to Practical Example 1 except that, to 100 mass parts of the coating resin, 4 mass parts of carbon black (#3230B, manufactured by Mitsubishi Chemical Corporation) were added.

Carrier of Comparative Example 3 was obtained in a manner similar to Practical Example 1 except that silicone resin (SR2400, manufactured by Dow Corning Toray Corp.) was dispersed in N-methyl-2-pyrrolidone to obtain coating resin.

Carrier of Comparative Example 4 was obtained in a manner similar to Comparative Example 3 except that, to 100 mass parts of the coating resin, 4 mass parts of carbon black (#3230B, manufactured by Mitsubishi Chemical Corporation) were added.

Table 1 shows the resin coat layer, the ratio of resins, the coating amount, and the conductive agent in the magnetic carriers of Practical Examples 1 to 6 and Comparative Examples 1 to 4 obtained in production example 3.

TABLE 1

| | | | | Conduc- |
|---|---|---|---|---|
| | | Resin | Coating | tive |
| Carrier | Resin Coat Layer | Ratio | Amount | Agent |
| Practical | Polyimide Silicone:Silica | 5:5 | 3 Mass Parts | |
| Example 1 | Particles | | | |
| Practical | Polyimide Silicone:Silica | 2:8 | 3 Mass Parts | |
| Example 2 | Particles | | | |
| Practical | Polyimide Silicone:Silica | 8:2 | 3 Mass Parts | |
| Example 3 | Particles | | | |
| Practical | Polyimide Silicone:Silica | 5:5 | 4 Mass Parts | Carbon |
| Example 4 | Particles | | | Black |
| Practical | Polyimide Silicone:Silica | 5:5 | 1 Mass Parts | Titanium |
| Example 5 | Particles | | | Oxide |
| Practical | Polyimide Silicone:Silica | 5:5 | 3 Mass Parts | |
| Example 6 | Particles ¹ | | | |
| Comparative | Polyimide Silicone | 10 | 3 Mass Parts | |
| Example 1 | | | | |
| Comparative | Polyimide Silicone | 10 | 3 Mass Parts | Carbon |
| Example 2 | | | | Black |
| Comparative | Silicone | 10 | 3 Mass Parts | |
| Example 3 | | | | |
| Comparative | Silicone | 10 | 3 Mass Parts | Carbon |
| Example 4 | | | | Black |

### Production Example 4

### (Production of Two-Component Developer)

The toner obtained in production example 2 and each of the carriers of Practical Examples 1 to 6 and Comparative Examples 1 to 4 obtained in production example 3 were blended so that the product had a toner concentration of 8 mass % (i.e., the added amount of toner was 8 mass parts in 100 mass parts, that is the total amount, of toner and carrier) and the product was stirred and mixed for 30 minutes using a rocking mixer to obtain two-component developer.

[Evaluation of Image Density and Image Fogging with Two-Component Developer]

Each of the two-component developers respectively containing the carriers of Practical Examples 1 to 6 and Comparative Examples 1 to 4 was loaded in a developing device in an evaluation machine (TASKalfa 500ci, manufactured by KYOCERA Document Solutions Inc.). In a normal-temperature normal-humidity environment (temperature: 23° C., humidity: 50%), continuous printing was performed on 5000 sheets at a coverage rate of 2% and on 5000 sheets at a coverage rate of 20%. After that, in a high-temperature high-humidity environment (temperature: 32.5° C., humidity: 80%), continuous printing was performed on 5000 sheets at a coverage rate of 5%. After that, back in a normal-temperature normal-humidity environment (temperature: 23° C., humidity: 50%), continuous printing was performed on 100,000 sheets at a coverage rate of 5%.

### (Image Density)

The solid image density (ID) of the print results was measured using a Macbeth reflection density sensor (RD914, manufactured by Gretag Macbeth Ltd.) at the following times: at the start of printing; then after printing on 5000 sheets at a coverage rate of 2%; then after printing on 5000 sheets at a coverage rate of 20%; then, in a high-temperature high-humidity environment, after printing on 5000 sheets at a coverage rate of 5%; then back in a normal-temperature normal-humidity environment, after printing on 100,000 sheets at a coverage rate of 5%. The evaluation criteria for image density were as follows:
Excellent: ID≥1.3 (very high image density, very good print result)
Good: 1.0≤ID<1.3 (high image density, good print result)
Poor: ID<1.0 (very low image density, poor image quality)

### (Image Fogging)

The fogging density (FD) in the blank part of the images of the print results was measured using a reflection density sensor (R710, manufactured by IHARA Corporation) at the following times: at the start of printing; then after printing on 5000 sheets at a coverage rate of 2%; then after printing on 5000 sheets at a coverage rate of 20%; then, in a high-temperature high-humidity environment, after printing on 5000 sheets at a coverage rate of 5%; then back in a normal-temperature normal-humidity environment, after printing on 100,000 sheets at a coverage rate of 5%. The fogging density (FD) was calculated according to formula (1) below:

$$FD = ( Reflection Density in Blank Part of Printing Sheet ) - ( Reflection Density on Unprinted Sheet )$$

The evaluation criteria for image fogging were as follows:
Excellent: FD≤0.005 (particularly low FD, very good print result)
Good: 0.005<FD≤0.010 (low FD, good print result)
Poor: FD>0.010 (very high FD, poor image quality)

### (Image Blurring)

After printing on 5000 sheets at a coverage rate of 5% in a high-temperature high-humidity environment followed by 24-hour standing still, a half-tone image was output to check for image blurring. The criteria for image blurring were as follows:
Excellent: No image blurring at all
Good: No image blurring, with slightly uneven image density in the half-tone
Poor: Noticeable image blurring

Table 2 shows the results of evaluation of image density, image fogging, and image blurring with each of the two-component developers respectively containing the carriers of Practical Examples 1 to 6 and Comparative Examples 1 to 4.

| | Normal-Temperature Normal-Humidity Environment | | | | | |
|---|---|---|---|---|---|---|
| | | | After Printing on 5k | | After Printing on 5k | |
| | Initial Stage | | Sheets at 2% | | Sheets at 20% | |
| | Image | | Image | | Image | |
| | Density | Fogging | Density | Fogging | Density | Fogging |
| Practical | 1.41/ | 0.000/ | 1.28/Good | 0.000/ | 1.42/ | 0.003/ |
| Example 1 | Excellent | Excellent | | Excellent | Excellent | Excellent |
| Practical | 1.39/ | 0.000/ | 1.26/Good | 0.002/ | 1.41/ | 0.004/ |
| Example 2 | Excellent | Excellent | | Excellent | Excellent | Excellent |
| Practical | 1.37/ | 0.001/ | 1.28/Good | 0.000/ | 1.40/ | 0.006/ |
| Example 3 | Excellent | Excellent | | Excellent | Excellent | Good |
| Practical | 1.41/ | 0.000/ | 1.35/ | 0.001/ | 1.41/ | 0.004/ |
| Example 4 | Excellent | Excellent | Excellent | Excellent | Excellent | Excellent |
| Practical | 1.39/ | 0.001/ | 1.34/ | 0.000 | 1.42/ | 0.003/ |
| Example 5 | Excellent | Excellent | Excellent | Excellent | Excellent | Excellent |
| Practical | 1.39/ | 0.000/ | 1.27/Good | 0.000/ | 1.40/ | 0.002/ |
| Example 6 | Excellent | Excellent | | Excellent | Excellent | Excellent |
| Comparative | 1.38/ | 0.000/ | 1.25/Good | 0.002/ | 1.40/ | 0.007/ |
| Example 1 | Excellent | Excellent | | Excellent | Excellent | Good |
| Comparative | 1.38/ | 0.000/ | 1.36/ | 0.002/ | 1.41/ | 0.007/ |
| Example 2 | Excellent | Excellent | Excellent | Excellent | Excellent | Good |
| Comparative | 1.40/ | 0.001/ | 1.24/Good | 0.001/ | 1.28/Good | 0.008/ |
| Example 3 | Excellent | Excellent | | Excellent | | Good |
| Comparative | 1.41/ | 0.000/ | 1.37/ | 0.000/ | 1.29/Good | 0.007/ |
| Example 4 | Excellent | Excellent | Excellent | Excellent | | Good |

| | | | | Normal-Temperature | |
|---|---|---|---|---|---|
| | High-Temperature High-Humidity | | | Normal-Humidity | |
| | Environment | | | Environment | |
| | After Printing on 5k | | | After Printing on 100k | |
| | Sheets at 5% | | | Sheets at 5% | |
| | Image | | Image | Image | |
| | Density | Fogging | Blurring | Density | Fogging |
| Practical | 1.38/ | 0.003/ | Excellent | 1.34/ | 0.003/ |
| Example 1 | Excellent | Excellent | | Excellent | Excellent |
| Practical | 1.37/ | 0.002/ | Excellent | 1.33/ | 0.006/ |
| Example 2 | Excellent | Excellent | | Excellent | Good |
| Practical | 1.37/ | 0.007/ | Excellent | 1.34/ | 0.004 |
| Example 3 | Excellent | Good | | Excellent | Excellent |
| Practical | 1.36/ | 0.004/ | Excellent | 1.33/ | 0.004/ |
| Example 4 | Excellent | Excellent | | Excellent | Excellent |
| Practical | 1.38/ | 0.005/ | Excellent | 1.33/ | 0.007/ |
| Example 5 | Excellent | Excellent | | Excellent | Good |
| Practical | 1.37/ | 0.001/ | Excellent | 1.34/ | 0.002 |
| Example 6 | Excellent | Excellent | | Excellent | Excellent |
| Comparative | 1.33/ | 0.008/ | Poor | 1.31/ | 0.003/ |
| Example 1 | Excellent | Good | | Excellent | Excellent |
| Comparative | 1.31/ | 0.009/ | Poor | 1.32/ | 0.004/ |
| Example 2 | Excellent | Good | | Excellent | Excellent |
| Comparative | 1.21/Good | 0.009/ | Poor | 1.30/ | 0.007/ |
| Example 3 | | Good | | Excellent | Good |
| Comparative | 1.15/Good | 0.010/ | Poor | 1.31/ | 0.008/ |
| Example 4 | | Poor | | Excellent | Good |

Table 2 reveals the following. The carriers of Practical Examples 1 to 6, in which the carrier core was coated using a resin coating liquid having silica particles mixed in polyimide silicone resin, proved to be excellent or good in both image density and image fogging after durability printing in a normal-temperature normal-humidity environment, after durability printing in a high-temperature high-humidity environment, and after durability printing back in a normal-temperature normal-humidity environment. They were also completely free from image blurring in a high-temperature high-humidity environment.

In particular, Practical Examples 4 and 5, in which silica particles were mixed in polyimide silicone resin to obtain resin coating liquid and in which a conductive agent was added to the resin coat layer, proved to be excellent in image density and image fogging after printing on 5000 sheets at coverage rates of 2% and 20% in a normal-temperature normal-humidity environment. On the other hand, Practical Example 6, in which hydrophobized silica particles were used, exhibited a stable charging ability in a high-temperature high-humidity environment and hence proved to be excellent in image density and image fogging in a high-temperature high-humidity environment.

In contrast, the carriers of Comparative Examples 1 and 2, in which the carrier core was coated using polyimide silicone resin alone, caused image blurring in a high-temperature high-humidity environment. Likewise, the carriers of Comparative Examples 3 and 4, in which the carrier core was coated using silicone resin alone, showed slightly reduced image density after printing on 5000 sheets at a coverage rate of 20% in a normal-temperature normal-humidity environment. It also exhibited a drop in image density after durability printing in a high-temperature high-humidity environment and caused image blurring.

The results above confirm the following. By using magnetic carrier of which the carrier core has its surface coated with polyimide silicone resin and silica particles, it is possible to obtain two-component developer that provides satisfactory image density at the start of printing, after durability printing, and in an high-temperature high-humidity environment and that can also suppress image fogging and image blurring.

The present disclosure finds application in magnetic carrier that electrostatically charges toner by friction. Based on the present disclosure, it is possible to provide magnetic carrier and two-component developer for electrophotography that have excellent charging and charge retaining abilities in a high-temperature high-humidity environment and that allows high-durability, high-quality development.

What is claimed is:

1. Magnetic carrier including:
a carrier core; and
a resin coat layer that coats a surface of the carrier core,
the magnetic carrier electrostatically charging toner positively by friction,
wherein
the resin coat layer contains polyimide silicone resin and silica particles.

2. The magnetic carrier according to claim 1, wherein
the resin coat layer contains a conductive agent.

3. The magnetic carrier according to claim 2, wherein
the conductive agent is carbon black or titanium oxide.

4. The magnetic carrier according to claim 1, wherein
the resin coat layer has the polyimide silicone resin and the silica particles blended in a mass ratio of 2:8 to 8:2.

5. The magnetic carrier according to claim 1, wherein
the silica particles has a volume median diameter of 30 nm or more but 100 nm or less.

6. The magnetic carrier according to claim 1, wherein
the silica particles are hydrophobized.

7. Two-component developer comprising:
the magnetic carrier according to claim 1; and
toner that is electrostatically charged positively by friction with the carrier.
